(19) United States
(12) Patent Application Publication
(10) Pub. No.: US 2016/0009468 A1
(43) Pub. Date: Jan. 14, 2016

(54) OVERCAPPING DEVICE AND IMPLEMENTATION METHOD

(71) Applicant: ARJOWIGGINS SECURITY, Boulogne Billancourt (FR)

(72) Inventor: Sandrine RANCIEN, Voiron (FR)

(73) Assignee: ARJOWIGGINS SECURITY, Boulogne Billancourt (FR)

(21) Appl. No.: 14/649,737

(22) PCT Filed: Nov. 27, 2013
(86) PCT No.: PCT/IB13/60447

§ 371 Date: Jun. 4, 2015

(30) Foreign Application Priority Data
Dec. 4, 2012 (FR) 1261606

(51) Int. Cl. B65D 55/08; B65D 51/18; B67B 5/03; B65D 51/24

(52) U.S. Cl. CPC B65D 55/0854; B65D 51/245; B65D 51/185; B67B 5/036; B65D 2555/025

(57) ABSTRACT

A method for securing a container, as example a bottle, including a closure device, or a stopper. The method includes: shrinking a heat-shrinkable security sleeve onto a portion of the container and the closure device, or over a neck and stopper of the bottle, the sleeve including at least one security element; and fitting a capsule, for example made from stamped metal or a metal complex, over the sleeve to only partially cover the sleeve, leaving the at least one security element on the sleeve at least partially visible.

The present invention relates to the field of packaging and in particular a capping device for vessels, this invention relating more particularly to a security sleeve and a capsule suitable for closely surrounding a part of a vessel, for example a container such as a bottle, comprising a closure device, for example a stopper.

Such capping devices constitute both a guarantee of authenticity and/or a certification of origin of the contents of the object and a guarantee of inviolability, and do so for all the parties involved in the production and distribution chain to the consumer.

Wine bottles, for example, currently have little or no security. In effect, immediately after the so-called operation of unlabeled storage by the producer or in the cooperatives, an operation which consists in filling the bottle and stoppering it with a closure device, for example a stopper, the bottles may be stored before they are labeled without having any capping device offering a guarantee of inviolability. Since these bottles comprise no security functions, a fraudulent adulteration of the wine in the bottle or a substitution of the wine by another wine is possible during this storage. Similarly, after the final operation of labeling of the bottle before its sale, an operation consisting in placing a front label and a back label on the body of the bottle and a capsule on the neck of the bottle, the bottle remains hardly secured.

In effect, the bottles of wine produced in France have, as their only capping device, a simple capsule, which may be made of aluminum or of stamped tin or based on a complex of wound/bonded polyethylene/aluminum or, more rarely, of PVC. The capsule is fitted by pneumatic systems on the top part of the bottle encompassing the closure device, the collar and the neck of the bottle. If the bottles are intended for sale in France, this capsule is provided on its head with a tax stamp or seal ornamented with the Marianne seal indicating that the fees on the alcohol have been paid in France, called “capsule representative of fee (CRD)”. The capsule, like the tax seal, include no security element offering a guarantee of authenticity and/or of inviolability.

The bottles of wine produced abroad and imported into France have a capsule from the producer without any stamp, on top of which is added, by the importer, a transparent capping sleeve bearing the CRD capsule. This transparent capping sleeve is also not secured, in that it offers no guarantee of authenticity and inviolability.

The stamped or wound/bonded capsule which is arranged on the closure device of a bottle of wine may be removed from the bottle by sliding, by being pulled upward, without being damaged, which makes it possible to access the closure device of the bottle, such as the stopper, and consequently also the contents of the bottle. The adulteration of the contents of the bottle is then possible, the consumer not benefiting from any integrity telltale or guarantee of inviolability which would guarantee that the contents of the bottle has not undergone fraudulent substitution or has not been the object of malicious alteration.

The stamped or wound/bonded capsule that does not currently carry any recognition element may also be easily counterfeited. The counterfeiters may in effect use empty grand cru bottles and copy the capsules to produce counterfeits. The consumer thus has no way of authenticating the bottle and its labeling, and of knowing with certainty whether the wine that has been bought does indeed come from the producer of said wine mentioned on the main label glued onto the front of the bottle.

The bottles of wine, after labeling with the labels and the capsule, further bear a batch number printed in clear, that is to say unencrypted, in the form of a barcode. This number is notably printed on the back label, that is to say the label glued onto the back of the bottle, opposite the main label. However, this batch number is not a unitary number specific to each bottle produced, and the individual traceability of the bottles in the case of a risk to public health is therefore impossible. Some wine producers proceed with a marking of an identifier or an individual code on the glass bottle but this individual code may pose reading problems because of weak contrast of the direct marking on the bottle.

The bottles of wine imported into France bear a sleeve positioned on their capsule. These transparent sleeves comprise no means of security guaranteeing the authenticity or the inviolability of the container. They are easy to remove because they are not positioned directly on the glass of the bottle. In effect, with the capsule tending to cancel the relief of the collar of the bottle, the sleeve may less easily closely follow the form thereof.

Security labels such as those marketed by the companies Prooftag or Tesa Scribos allow for the traceability of the bottles by virtue of the presence of a unique identifier. They are sometimes positioned straddling the capsule and the neck of the bottle in order to provide a guarantee of inviolability. To remove the capsule from the bottle without damaging it and access the wine, it is then necessary to remove said label, making it more difficult to adulterate the wine. Nevertheless, these labels are easy to unstick and reposition by using known means, without altering either the capsule or the label itself.

It is known practice from the application GB 2 273 492 to have, on all sorts of objects, a heat-shrinkable sleeve made of plastic material, comprising a tear tape consisting of a holographic element and micro-perforations. It is thus difficult to remove the sleeve without damaging the holographic element.

The patent application FR 2 754 375 describes a heat-shrinkable sleeve made of plastic material, intended to be fitted onto the neck of a bottle, partly covering the stopper. The sleeve is provided with a holographic element and a tear tape. With the holographic element being partly glued to the glass of the bottle, by pulling the tear tape when legitimately opening the bottle or attempting to tear it, residual fragments thereof remain on the bottle. This device is relatively complex to manufacture.

The patent application GB 2 298 391 describes a heat-shrinkable film, that may take the form of a sleeve, comprising a substrate including a holographic element and adhesive layers. This film is intended to be inserted between an object and its packaging, so as to reveal any alteration of the packaging.

The application EP 0 585 076 describes a holographic security tape intended to be inserted on a packaging material. The tape comprises a thermoplastic film and a layer of adhesive used for the insertion on the material. The film and the tape do not make it possible to ensure the integrity of the contents of the packaged object.

There is therefore a need to safely secure and authenticate the containers with a closure device, in particular the wine bottles closed by a stopper, by adding an authentication and/or identification and/or traceability means as well as a guarantee of inviolability, allowing for a reliable detection of any fraudulent or abnormal manipulation of the container and/or of its contents.

The invention aims to satisfy this need, and it achieves this by virtue of a method for securing a container, notably a bottle, comprising a closure device, notably a stopper, in which:
a heat-shrinkable security sleeve, notably made of plastic, is shrunk over a part of the container and the closure device, notably over the mouth and the stopper of the bottle, this sleeve comprising at least one security element, and
a capsule, notably made of stamped metal or of a metal complex, such as a wound/bonded metal complex, is fitted over the sleeve in such a way as to cover it only partially, leaving said at least one security element of the sleeve at least partially visible.

By virtue of the invention, at least one security element borne by the sleeve may be directly authenticated and does not interfere with any inscriptions appearing on the capsule.

For its fitting, the heat-shrinkable security sleeve is heated in order for it to be shrunk around the container and its closure device, for example the mouth and the stopper in the case of a bottle. A better conformation to the relief of the end of the container is thus possible. Furthermore, with the sleeve being able to be in direct contact with the material from which the part of the container surrounded by the sleeve is produced, the latter closely follows the outer surface of the container and has a better adhesion thereto, thus being more difficult to remove.

“Sleeve shrunk onto a part of the container and of the closure device” should be understood to mean that the sleeve covers a part of the container and of the closure device. The sleeve preferably comes directly into contact with the container and may or may not come directly into contact with the closure device. In the case where the latter is a stopper fitted into the neck of a bottle, the sleeve may come into contact with the top end of the stopper or cover it at a short distance, directly facing it.

The features which will be described hereinbelow apply equally to the method and to the secured container and its secured closure device, obtained by the implementation of the method described previously, comprising:
a heat-shrinkable security sleeve, notably made of plastic, fixed by heat-shrinking onto the container and comprising at least one security element,
a capsule, notably made of metal or of a metal complex, covering the sleeve only partially, leaving said at least one security element borne by the sleeve at least partially visible.

The sleeve is advantageously arranged in such a way that, when it has been shrunk, it covers the closure device at least partially so that any fraudulent attempt to extract the closure device with the sleeve in place visibly alters the sleeve.

The sleeve for example partially covers the outer end of the closure device of the container, that is to say the end which has no contact with the contents thereof, when the closure device is in place. In the case, notably of a bottle, containing wine for example, and closed by a stopper, this makes it possible to prevent the extraction thereof without visibly altering the sleeve.

The sleeve may also be arranged in such a way that, when it has been shrunk, it does not totally cover the closure device so that, for example for a bottle of wine, the contents of the bottle may also breathe through the stopper and the capsule which is then pierced for that purpose.

The security sleeve may be fitted, as currently, during the final labeling of the bottle, that is to say with its label and its back label, but in a preferred embodiment it may be fitted onto the bottle of wine just after the operation of unlabeled storage directly on the premises of the producer or in the cooperative, which makes it possible to secure and trace the bottle as early as possible in the production chain, that is to say just after it has been filled. Thus, adulteration and counterfeiting attempts before labeling may be avoided.

After having been shrunk, the sleeve preferably covers 5% to 100% of the total surface of the outer end of the closure device of the container.

In a variant, the sleeve, once heat-shrunk, covers only the sides of the closure device fixed onto the container, and not the top of the device, for example in the case where the container is a vessel closed by a cap or a screw cap.

The security sleeve, once shrunk onto the container, may have a skirt length greater than the length of the skirt of the capsule of the container, and thus extend beyond the capsule by a lower end part, on which at least one security element may be present.

In another variant, the heat-shrinkable security sleeve comprises at least in its lower part not covered by the capsule, at least one identifier.

Preferably, the lower part of the sleeve extending beyond the capsule may also have an identifier, for example an individual identification code marked by printing or etching on the lower part of the skirt.

The upper part of the sleeve situated opposite that extending beyond the capsule may comprise at least one second security and/or authentication and/or inviolability and/or traceability and/or identification element.

The security sleeve comprises, preferably in its upper part, a release means, notably micro-perforations or micro-cuts and/or a tear tape. This release means facilitates the removal of the upper part of the sleeve which protects the opening device, when the container is opened manually by the final consumer. The presence of this release means, which irreversibly alters the security sleeve upon the opening of the container, thus warns of any fraudulent act on the container or the contents.

The micro-perforations or micro-cuts may be arranged in the form of horizontal or vertical lines on the security sleeve or else according to a particular pattern, so as to lead to an inevitable tearing of the sleeve upon its removal and prevent the replacement thereof on the container after having accessed its contents.

The release means may consist of at least one horizontal line of micro-perforations and of at least one vertical line of micro-perforations.

The horizontal line of micro-perforations of the release means may for example be situated on, above or below the collar of the container, for example in the case of a bottle of wine.

The vertical line of micro-perforations of the release means may for example be situated in the axis of revolution of the container, perpendicularly to the collar and/or to the neck of the container in the case of a bottle of wine.

In a variant, the release means comprises or consists of two vertical and parallel lines of micro-cuts.

In another variant, the release means comprises or consists of two vertical and parallel lines of micro-cuts and one horizontal line of micro-perforations, at right angles to the vertical lines of micro-cuts.

In yet another variant, the release means comprises or consists of two parallel and vertical or horizontal lines of micro-perforations and one tear tape situated between these two lines.

The release means of the sleeve is preferably placed at the level of a security element of the sleeve; for example, it may cross this security element, notably at right angles. It is thus easy to reveal, through the alteration of the security element of the sleeve, any attack on the integrity of the container.

The release means of the sleeve, notably the tear tape, may further itself comprise at least one security element, facilitating its authentication. It may also comprise an antenna providing an anti-theft function.

The release means, notably the tear tape, may further comprise a tongue for gripping the tear tape, facilitating its actuation by the user. This gripping tongue may itself bear a security element.

After the actuation of the release means and the tearing away of the upper part of the sleeve, in the case where the contents of the container is liquid, the remaining part of the sleeve may advantageously serve as means for draining said contents when it is poured.

The security element or elements present in the lower part of the skirt of the security sleeve not covered by the capsule and/or in the upper part of the security sleeve may have a so-called first, second or third level security feature.

“First level security” should be understood to mean a security element visible to the naked eye, in daylight or in artificial light, without the use of a particular apparatus. These first level security elements can be first level elements with optically variable effect, such as, for example, interferential platelet particles, magnetic or not, liquid and/or oriented and/or photonic crystals, a holographic element or a lens array in combination with an underlying pattern.

“Second level security” should be understood to mean a security element still visible to the naked eye but only using a relatively simple apparatus, such as lamp emitting in the ultraviolet (UV) or the infrared (IR) or a magnifying glass or an optical filter-type decoding tool or a polarizing filter. These second level security elements are, for example, luminescent, that is to say exhibit a specific emission in the visible under the lighting of a Wood lamp emitting in the UV for example at a wavelength of 365 nm. These second level elements may also be anti-stokes elements, that is to say elements that exhibit a specific emission in the visible under the light of an IR pointer for example at a wavelength of 980 nm. Second level security should also be understood to mean security that may be revealed by the application of heat and/or by friction.

“Third level security” should be understood to mean a security element that requires a dedicated detection apparatus for its detection. These security elements are for example capable of generating a specific signal when they are subjected, simultaneously or not, to one or more external sources of stress. This signal is processed then analyzed by a dedicated detection apparatus in order to authenticate or identify the element. These security elements comprise, for example, tracers or materials that take the form of active substances, particles or fibers, capable of generating a specific signal when these tracers are subjected to a mechanical, thermal, optronic, electrical, magnetic or electromagnetic stress.

The security element or elements of the sleeve may take the form of a print, a wire, a flat strip, a foil or a patch, being applied onto the inner or outer face of the sleeve. The security element or elements of the sleeve may also be incorporated in the polymer mass of the heat-shrinkable sleeve.

The security element or elements may in particular be printed on the inner face of the sleeve in contact with the glass. In effect, the sleeve is obtained from a film folded on itself followed by a joining of the two free edges. This film, before folding, may be printed by well known printing methods, such as photogravure, screen-printing, flexography or offset. In a preferred mode of execution, the film is printed with first, second and/or third level security inks in the lower part of the skirt of the sleeve which will remain visible after the sleeve has been shrunk onto the container to be protected and the capsule has been fitted. The security prints present on the sleeve will be produced in such a way that they remain visible and/or detectable after the sleeve has been shrunk onto the container and its closure device, by the use of anamorphic techniques.

The first level security element or elements present on the lower and/or upper part of the security sleeve may be elements with optically variable effect, such as for example interferential platelet particles, magnetic or not, liquid and/or oriented and/or photonic crystals, a holographic element or an array of lenses in combination with an underlying pattern. The second level security element or elements present on the lower part and/or the upper part of the security sleeve may be elements invisible to the naked eye under day lighting but visible under a lighting of particular wavelength.

The security sleeve may also comprise thermochromic elements, notably liquid crystals and/or pigments and/or thermochromic colorants, that may change appearance at at least one predefined temperature. The container may then comprise at least one information item associated with the thermochromic elements, giving information on the temperature at which the thermochromic elements change appearance, qualitatively and/or quantitatively, and on the temperature of the container and approximately that of its contents.

The appearance of the thermochromic elements, for example their coloring or their transparency, varies as a function of the temperature to which they are subjected. The process of variation of the appearance of the thermochromic elements is preferably reversible. The information may correspond to the numeric value of the temperature at which the thermochromic elements change appearance.

The security sleeve may also comprise an RFID device comprising an integrated circuit, with or without integrated battery, with or without microprocessor, with or without a sensor, for example for recording the temperature.

The sleeve may comprise the following security elements, alone or in combination:
colorants and/or luminescent pigments and/or interferential pigments and/or liquid crystal pigments, notably in printed form or mixed with a constituent material of the sleeve,
photochromic or thermochromic components, colorants and/or pigments, arranged so as to indicate the temperature of the container and therefore approximately that of its contents, notably in printed form or mixed with a constituent material of the sleeve,
a multilayer interferential film,
a structure with variable optical effects based on interferential pigments or liquid crystals,
a birefringent or polarizing layer,
a diffraction structure,
an embossed image,
a partially reflecting refractive element,
a metalized, goniochromatic or holographic foil,
a layer with variable optical effect based on interferential pigments or liquid crystals,
particles or agglomerates of particles of pigments or colorants of HI-LITE type, visible or invisible, notably luminescent,
security fibers, notably metallic, magnetic (with soft and/or hard magnetism), or absorbent, or that may be excited in the ultraviolet, the visible or the infrared, and in particular the near infrared (NIR),
an automatically readable security having specific and measurable characteristics of luminescence (for example fluorescence, phosphorescence), of light absorption (for example ultraviolet, visible or infrared), of Raman activity, of magnetism, of microwave interaction, of RF interaction, of interaction with X rays or of electrical conductivity.

The sleeve may further comprise, preferably in its part not covered by the capsule, at least one visible authentication element, such as, for example, a holographic foil, security prints with OVI type variable optical effect, or authenticatable recognition elements dispersed in the material of the sleeve.

The sleeve may also comprise, in its lower part not covered by the capsule, at least one identifier of individual identification code type having a track and trace function, such as, for example, a two-dimensional barcode, a two-dimensional barcode of the Datamatrix type or an alphanumeric code written in clear. This code may or may not be encrypted. This identifier or code may be marked by any means and preferably by means of an iridescent visible ink or an invisible ink containing, for example, luminescent pigments under UV, thus producing a track and trace function as well as an authentication function.

The sleeve may also comprise, in its lower part not covered by the capsule, at least one visible two-dimensional code of “quick response” (QR) or Datamatrix type, making it possible to address, via a communicating device such as a telephone (of Smartphone type for example), a website of the producer or of the certifying organization via which any party involved in the chain including the consumer will be able to gather information on the contents and proceed to verify the identifier inscribed on the bottle.

In a variant or in combination, the sleeve may also comprise, in its lower part not covered by the capsule, a code making it possible to address, via a communicating device such as a telephone (of Smartphone type for example), a website of the producer or of the brand of the contents, in order to obtain, for example, information relating thereto. This code may be a two-dimensional barcode. This code is advantageously unique and printed identically on all the containers of one and the same brand or of one and the same producer.

The heat-shrinkable security sleeve may also have, in its lower part, notably at the level of the security element and/or of the identifier, an opaque appearance providing sufficient contrast, notably for the automatic authentication of the security element and/or the automatic identification of the identifier.

Preferably, the lower part of the sleeve has, at the level of the individual identification code and/or of the QR code, a sufficient contrast to allow for it to be read. This contrast may be provided by a print that is localized or over all the surface, preferably on the inner face of the sleeve in contact with the glass facing the code. This contrast may be provided in particular by an opaque print offering a different color form that used for the marking.

The sleeve may be produced from one of the following plastic materials: PVC, PVC HR, PET, PETG, PS, OPS (oriented polystyrene), OPP (oriented polypropylene), TPEG, TPE S, PLA (polylactic acid), EPS (expanded PS), etc. Preferably, a security sleeve material and thickness is chosen which provides strength against cutting so that the sleeve is not cut or sheared when the capsule is removed by the consumer.

The security sleeve may comprise, on its inner or outer surface, a primer or varnish, for example of the heat-activatable type, allowing an enhanced adhesion between the security sleeve and the container to be protected and/or between the security sleeve and the capsule.

The tear tape, when present in the release means, may or may not be produced from the same heat-shrinkable plastic material as the security sleeve.

The security element or elements of the sleeve may be situated on the inner face of the sleeve, that is to say the face which is in contact with the container, in order to be protected from wear or from damage and avoid the possibility of access thereto in falsification attempts. The sleeve is then preferably produced from a transparent material, in order for such security elements to be visible or detectable optically through the material of the sleeve.

In a variant, the security element or elements of the sleeve and notably an individual identification code are situated on the outer face of the sleeve; in effect, such personalized information which will be read with dedicated readers may be marked by printing or etching, after the sleeve shrinking operation, on a part of the container capping device and notably on the sleeve.

The sleeve, before heat-shrinking, preferably has a cylindrical or conical form.

The length of the skirt of the sleeve may be between 6 and 8 cm, being for example equal to approximately 7 cm.

The thickness of the sleeve may be between 40 and 100 μm before shrinking.

According to another of its aspects, the subject of the invention is a heat-shrinkable security sleeve for the implementation of the method according to the invention, the sleeve being suitable for being fitted onto the closure device of a container, prior to the fitting of a capsule, notably made of stamped metal or of a metal complex, the sleeve comprising at least one security element, the sleeve being arranged in such a way that the capsule covers it only partially leaving said at least one security element of the sleeve at least partially visible.

Notably in the case of the use on a bottle, the security element may be present in the lower part of the sleeve, notably in the vicinity of the bottom end, preferably in a strip 0 to 2 cm high from the bottom edge of the capsule.

According to yet another of its aspects, the subject of the invention is an assembly for securing a container comprising a closure device, the assembly comprising:
a heat-shrinkable security sleeve according to the invention, and
a capsule, notably made of stamped metal or of a metal complex, intended to protect the container at the level of the closure device, arranged to cover the sleeve only partially after having fitted over the latter.

The characteristics stated previously apply to such an assembly. Thus, as indicated above, the security sleeve advantageously has a skirt length greater than that of the capsule, so as to extend beyond the latter.

The invention will be able to be better understood on reading the following detailed description, of nonlimiting exemplary implementations thereof, and on studying the attached drawing, in which:

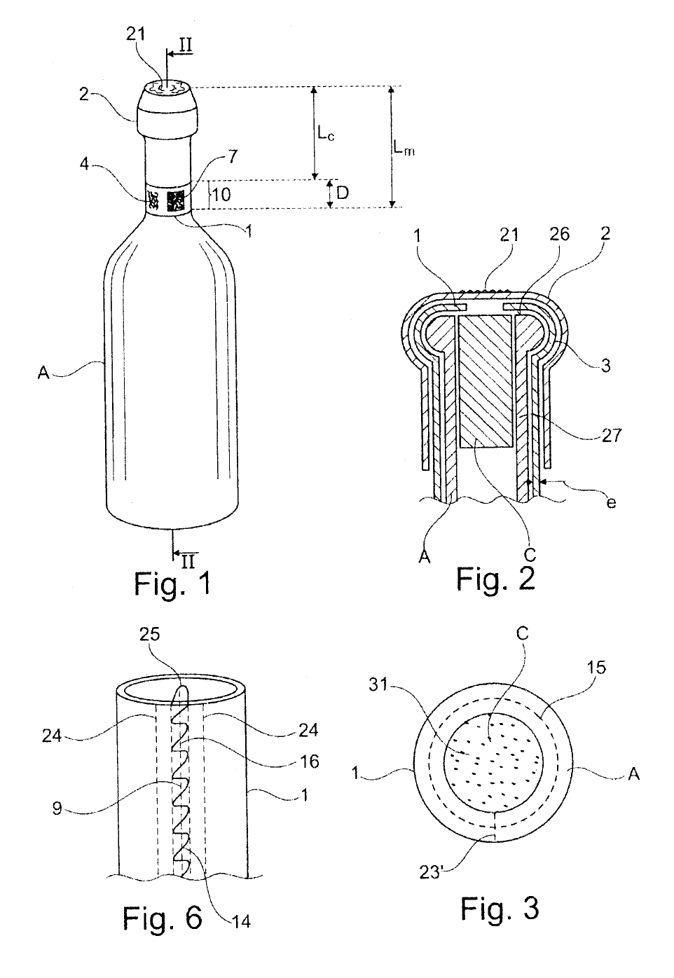

FIG. 1 represents, in elevation, a container secured using a security sleeve and a capsule according to the invention,

FIG. 2 is a partial view of the upper part of the secured container in axial cross section according to II-II of FIG. 1,

FIG. 3 is a partial plan view of the container of FIG. 1 with the security sleeve but with the capsule removed,

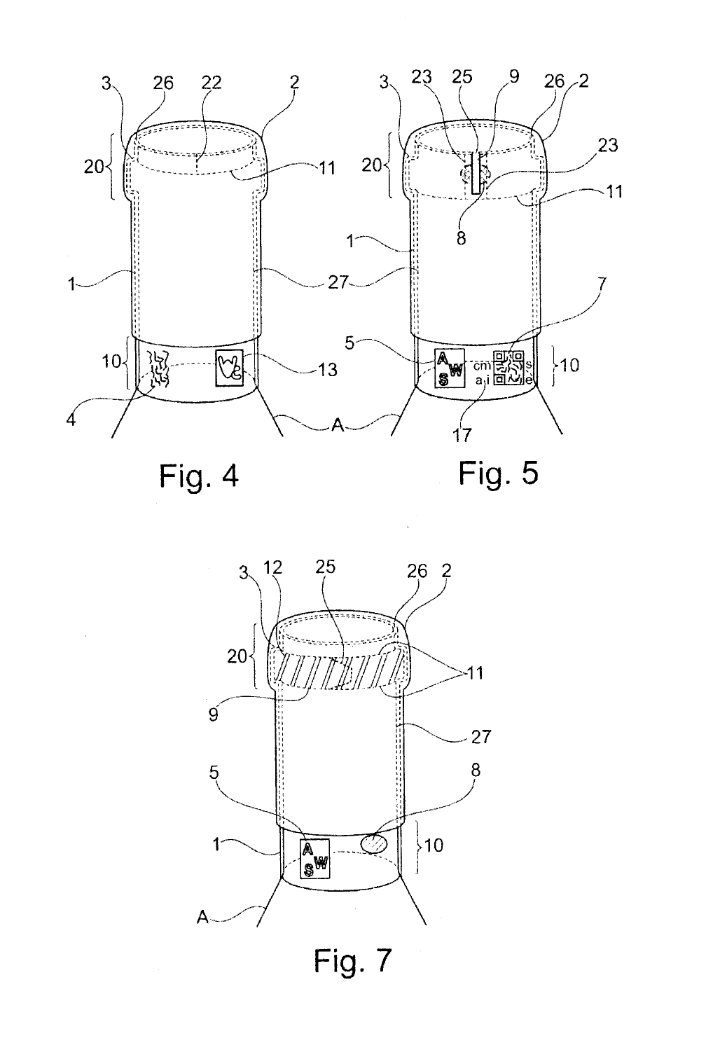

FIG. 4 is a partial view, in elevation, of the container of FIG. 1 secured using a security sleeve and a capsule according to the invention,

FIG. 5 is a view similar to FIG. 4 of a variant embodiment,

FIG. 6 represents, in isolation, the upper part of a security sleeve according to the invention, before heat-shrinking, and

FIG. 7 is a view similar to FIG. 4 of a variant embodiment.

In the attached drawing, the real proportions of the various constituent elements or their spacings have not always been observed in the interests of clarity. Moreover, certain elements may not have been represented in contact with one another, whereas they are in practice.

The container A to be secured represented in FIG. 1 is a bottle and contains a liquid, wine in the example considered. The bottle A comprises a capping device consisting of a security sleeve 1 closely surrounding the upper part of the bottle, that is to say the neck 27 and the mouth 26 which comprises the collar 3, and a stamped capsule 2. The security sleeve 1, after shrinking onto the upper part of the bottle A, closely follows the neck 27 and the mouth 26 thereof.

The container A is provided with a closure device C, which is, in the example of FIGS. 1 to 7, a stopper, for example of cork, driven into the mouth 26 of the bottle. The invention is not however limited to one particular type of closure device, which could be a screw cap.

As represented in FIG. 2, the security sleeve 1 surrounds the upper part of container A and a part of the closure device C, in order to ensure the protection thereof.

The capsule 2 is fitted from above the security sleeve 1 so that the lower part of the skirt thereof is not totally covered by the skirt of the capsule 2 and is left visible. The capsule 2 is made of metal, for example of stamped aluminum in the example of FIGS. 1 to 7, and comprises, for example, a color print background and a decoration with inscriptions printed on the sides of its skirt, and a cap representative of fees 21 on the head of the capsule 2. The inscription of the cap representative of fees 21 is for example printed by screen-printing. The invention is not however limited to one particular type of capsule 2.

The security sleeve 1 is produced and shrunk on the upper part of the container A in such a way that the lower part 10 of the skirt of the sleeve 1 is not covered by the skirt of the capsule 2 after the latter is fitted over the sleeve. Thus, the security sleeve 1, once shrunk onto the container A, has a skirt length Lₘ, measured from the top end of the container A to the bottom end of the security sleeve 1, greater than the skirt length L_{c} of the capsule 2. The difference D between the length Lₘ of the security sleeve 1 and the length L_{c} of the capsule 2 is for example between 0.5 and 2.5 cm. The skirt length Lₘ, of the security sleeve 1 is for example between 6 and 8 cm.

The security sleeve 1 comprises, in its lower part 10, at least one security element, for example a security element 4 and an individual identification code 7, specific to the container A, as illustrated in FIG. 1.

After the security sleeve 1 has been shrunk onto the upper part of the container A, the top edge of the security sleeve, as represented in FIG. 3, covers, by a crown 15, the outer end 31 of the closure device C. In the example described, the security sleeve 1 covers approximately 50% of the total surface area of the outer end 31 of the closure device C of the container A. In this example, the sleeve 1 is provided with a line of vertical micro-perforations 23′.

The security sleeve 1 is, in the examples described, substantially cylindrical of revolution before shrinking for it to be fitted onto the mouth 26 of the bottle. The invention is not however limited to a particular form of sleeve, and its section may be non-circular.

As represented in FIG. 4, the security sleeve 1 may comprise, in its upper part 20, a release means, consisting in the example of this figure of two lines of micro-perforations, one horizontal 11 and the other vertical 22, which intersect. The horizontal line 11 is, in the example described, placed just above the collar 3 but, in a variant, may be present below, as illustrated in FIG. 5. These micro-perforations define a preferential rupture zone, which facilitates the opening of the sleeve 1.

In the variant represented in FIG. 5, the security sleeve 1 comprises, in its upper part 20, a release means consisting of two vertical and parallel lines of micro-cuts 23, a tear tape 9 between these two vertical and parallel lines and a horizontal line of micro-perforations 11, which intersects the two vertical lines of micro-perforations. The tear tape 9 comprises, in the example described, at its end, a gripping tongue 25 on which the user may pull to open the security sleeve 1. The invention is not however limited to a particular type of release means.

As represented in FIG. 6, the security sleeve 1 may have two vertical and parallel lines of micro-perforations 24 and a tear tape 9 between these two lines, the tear tape 9 conveying a first level security element such as, for example, a holographic foil 14, over the entire length of the sleeve 1. The side of the tear tape 9 which is not visible may comprise an antenna wire 16 likely to be detected by electromagnetic anti-theft devices. In case of opening, all of the sleeve 1 is removed from the bottle A.

As represented in FIG. 7, the security sleeve 1 may have two horizontal and parallel lines of micro-perforations 11 and a tear tape 9 comprising a gripping tongue 25. The tear tape 9 comprises, in the example described, at its end, a gripping tongue 25 on which the user may pull to open the security sleeve 1. The tear tape 9 is advantageously positioned, in the example described, in such a way as to cover all of the collar 3, and may convey a first level security element such as a lenticular foil 12, with an inscription provided with an effect of movement as a function of the orientation. Thus, even if the sleeve 1 is cut at the same time as the capsule 2 at the level of the collar 3, the lower part of the security sleeve 1 comprising at least one security element remains in place. The tear tape 9 may be as described in the application EP 1 082 256.

The lower part of the security sleeve 1 comprises, in the example of FIG. 4, a security element 4 in the form of a second level security print, invisible in daylight but visible only under a UV wavelength, previously printed on the inner face of the film of the sleeve 1 before folding during production, and a security element 13 in the form of a third level security print based on a tracer, detectable in the IR only with a dedicated reader, printed also on the inner face of the film of the sleeve before folding.

As illustrated in FIG. 5, the security sleeve 1 may comprise, in its bottom part 10, a first level security element 5 in the form of a print with variable optical effect of OVI type, visible to the naked eye and previously printed on the outer face of the film of the sleeve 1 before folding.

The lower part 10 of the security sleeve 1 comprises, in the example of FIG. 5, just like in the example of FIG. 1, an individual identification code 7 allowing for a track function for the container A, and consists here of a two-dimensional barcode of Datamatrix type. The individual identification code 7 is printed with a black ink on the outer face of the sleeve after it has been shrunk onto the container, the print offering a sufficient contrast on the print background of the sleeve 1 to allow it to be automatically read. The film of the sleeve 1 is also printed in this example with an opaque and colored print background and with inscriptions 17 in the name of the château.

In a variant not represented, the two-dimensional barcode 7 may have no identification or track function, and may make it possible to address, via a communicating device such as a telephone (of Smartphone type for example), a website of the producer or of the brand of the contents, in order to obtain, for example, information relating thereto. This code is advantageously unique and printed identically on all the containers A of one and the same brand or of one and the same producer.

The upper part 20 of the security sleeve 1 comprises, in the example of FIG. 5, a security element 8, for example a visible first level element of print with variable optical effect type, placed straddling the area delimited by the two lines of micro-cuts 23 and the rest of the security sleeve 1, thus making it possible to reveal any fraudulent manipulation of the container if the security element 8 is altered.

The security elements of the security sleeve 1 are preferably optically variable first level security elements. In a variant, these security elements are of any other type, as listed previously, the invention not being limited to a particular type of security element. Similarly, the security elements have been represented with a substantially circular or rectangular contour, but the invention is in no way limited to a particular form of security element.

The security sleeve 1 is produced in a heat-shrinkable plastic material, for example PET.

The tear tape 9 is advantageously produced in the same heat-shrinkable plastic material as the security sleeve 1.

In the examples described above, the security sleeve 1 is preferentially produced in a transparent material. In a variant not illustrated, the security sleeve 1 is produced in an opaque material.

At least one of the security elements of the sleeve 1, when the material thereof is transparent, is situated on the inner face of the sleeve, that is to say the face which is in contact with the container A, as for example in the examples of FIG. 4, where the sleeve 1 comprises a first level security element 4 situated on its inner face.

At least one of the security elements of the sleeve 1, when the material thereof is transparent, is situated on the outer face of the sleeve, as for example in the examples of FIGS. 4 and 5, where the sleeve 1 comprises first level security elements 8 and 13 situated on the outer face of the security sleeve 1, which may enhance their appearance and their visibility.

The thickness of the security sleeve 1 is for example between 40 and 100 μm before shrinking.

A sleeve according to the invention may be used in the field of packing, of packaging in general, in particular for consumption products such as food, chemical, cosmetic or pharmaceutical products. The invention makes it possible to secure and authenticate the product as early as possible in the production chain, that is to say just after its filling. Thus, thefts and counterfeits before labeling may be avoided.

The invention is not limited to the examples which have just been described. It is notably possible to combine particular production features of the different examples illustrated, in variants not illustrated.

The invention is notably not limited to a particular type or form of container, or to a particular type of contents.

The expression “comprising one” should be understood to be synonymous with “comprising at least one”.

1-24. (canceled)

25. A method for securing a container, or a bottle, comprising:
a closure device, or a stopper, in which:
a heat-shrinkable security sleeve is shrunk over a part of the container and the closure device, or over a mouth and the stopper of the bottle, the sleeve comprising at least one security element; and
an overcapping capsule, or an overcapping capsule made of stamped metal or of a metal complex, fitted over the sleeve to cover the sleeve only partially, leaving the at least one security element of the sleeve at least partially visible.

26. The method as claimed in claim 25, wherein the sleeve is heated to be shrunk around the container, or around the mouth of the bottle.

27. The method as claimed in claim 25, wherein the sleeve is arranged such that, when the sleeve has been shrunk, the sleeve covers the closure device at least partially such that any fraudulent attempt to extract the closure device with the sleeve in place visibly alters the sleeve.

28. A secured container obtained by implementation of the method as claimed in claim 25, comprising:
a heat-shrinkable security sleeve fixed by heat-shrinking on the container and comprising at least one security element;
an overcapping capsule, or an overlapping capsule made of stamped metal or of a metal complex, covering the sleeve only partially, leaving the at least one security element borne by the sleeve at least partially visible.

29. The container as claimed in claim 28, the sleeve, once shrunk onto the container, having a skirt length greater than a length of the capsule.

30. The container as claimed in claim 28, an upper part of the sleeve comprising at least one security element.

31. The container as claimed in claim 28, the sleeve comprising, or in its upper part, a release means, or micro-perforations or micro-cuts and/or a tear tape.

32. The container as claimed in claim 31, the release means comprising at least one horizontal line of micro-perforations and of at least one vertical line of micro-perforations.

33. The container as claimed in claim 32, the horizontal line of micro-perforations being situated above a collar of the container.

34. The container as claimed in claim 32, the horizontal line of micro-perforations being situated below a collar of the container.

35. The container as claimed in claim 31, the release means comprising two vertical and parallel lines of micro-cuts and one horizontal line of micro-perforations, at right angles to vertical lines of micro-cuts.

36. The container as claimed in claim 31, the release means comprising two parallel and vertical lines of micro-perforations and one tear tape situated between the two lines.

37. The container as claimed in claim 36, the release means of the sleeve being placed at a level of at least one of the security elements of the upper part of the sleeve.

38. The container as claimed in claim 31, the release means of the sleeve bearing at least one security element.

39. The container as claimed in claim 31, the release means comprising a tear tape and the tear tape bearing an antenna wire.

40. The container as claimed in claim 28, at least one security element of the sleeve being an optically variable element.

41. The container as claimed in claim 28, at least one security element of the sleeve being situated on an inner face thereof and/or at least one security element of the sleeve being situated on an outer face thereof.

42. The container as claimed in claim 28, the sleeve being produced in a transparent heat-shrinkable plastic material.

43. The container as claimed in claim 28, at least one security element of the sleeve being an identification element and/or an authentication element and/or a traceability element.

44. The container as claimed in claim 28, the sleeve further comprising a code specific to the container and making it possible to address, via a communicating device, a website, or the code being a two-dimensional barcode.

45. A heat-shrinkable security sleeve for implementation of the method as claimed in claim 25, the sleeve configured to fit onto the closure device of a container, prior to fitting of an overcapping capsule, or made of stamped metal or of a metal complex, the sleeve comprising at least one security element,
the sleeve being arranged such that the capsule covers the sleeve only partially leaving the at least one security element of the sleeve at least partially visible.

46. The heat-shrinkable security sleeve as claimed in claim 45, comprising, at least in its lower part not covered by the overcapping capsule, at least one identifier.

47. The heat-shrinkable security sleeve as claimed in claim 45, comprising, in its lower part, or at a level of the security element and/or of the identifier, an opaque appearance providing sufficient contrast, or for automatic authentication of the security element and/or the automatic identification of the identifier.

48. An assembly for securing a container comprising a closure device, the assembly comprising:
a heat-shrinkable security sleeve as defined in claim 47; and
an overcapping capsule, or made of stamped metal or of a metal complex, configured to protect the container at a level of the closure device, arranged to cover the sleeve only partially after having been fitted over the sleeve.
